(19) United States
(12) Patent Application Publication
(10) Pub. No.: US 2011/0099099 A1
(43) Pub. Date: Apr. 28, 2011

(54) SYSTEM AND METHOD FOR VALIDATING COLLATERAL

(75) Inventors: Sergo RIVEST, Mississauga (CA); Michael KING, Aurora (CA); Richard CLARK, Markham (CA)

(73) Assignee: DAVIS + HENDERSON, LIMITED PARTNERSHIP, Toronto, (CA)

(21) Appl. No.: 12/909,771

(22) Filed: Oct. 21, 2010

(30) Foreign Application Priority Data
Oct. 22, 2009 (CA) 2683395

(51) Int. Cl. G06Q 40/00

(52) U.S. Cl. 705/35

(57) ABSTRACT

The invention consists of a method for real-time registration of collateral for a loan, comprising: a) inputting collateral information into a form; b) verifying the collateral information in the form via a self-checking algorithm; c) submitting the collateral information to a registration service; and d) providing confirmation that the collateral information was recorded with the registration service.

### FIELD OF THE INVENTION

The present invention relates to the field of financial management. In particular, it relates to a system and method for validating collateral.

### BACKGROUND OF THE INVENTION

For a lender, one of the concerns is the proper identification and valuation of the collateral for a loan. A related concern is then the proper recording of a security interest against that collateral according to the appropriate regime. For loans against collateral other than real estate, this recording must be done according to the appropriate regime. Examples of such regimes are the PPSA (Private Property Security Act) in the Provinces of Canada and the UCC (Uniform Commercial Code) in some of the States of the United States.

Due to the volume of loan transactions which take place, large lending institutions, particularly banks, typically use an agency service to record the various security interests as they are approved. Agents are used to facilitate the payment process of the government fees charged for recording a security interest.

The agency is responsible for re-inputting the request data into their system for transmittal to the government registry. Generally, multiple requests are combined into a batch and forwarded to the government registry on a periodic basis (hourly, daily) as required by volume.

The agent receives a response from the government agency containing a verification statement and a registration number, which is then returned to the lending institution as proof that the security interest was recorded. The process is typically operated on a next-day confirmation basis. That is, the security interest is recorded the day of the transaction, however, confirmation is not received until the next business day.

This process creates some vulnerability. First, the need for the agent to re-input the security interest data into their system for transmittal to the government agency creates a risk of error during the data input process. An incorrect name, address, or identification of the collateral can render the registration invalid and negate the interest that is otherwise presumed to be good.

Second, the process creates a delay before the validation of the registration. This delay provides the possibility that an unscrupulous party could seek multiple loans on the same piece of collateral on the same day from multiple lenders without the lenders being able to gain knowledge of the previous transactions. This risk of fraud has led to insurance being provided to cover the “gap” between the time of the loan transaction and the time of registration. While insurance has been as efficient as would be expected in preventing and covering this scenario, the need for insurance results in increased costs and complexity to the transaction.

With these limitations in mind, there is a need for a real-time method of security interest recording that obviates or mitigates the need for “gap” insurance. There is also a need for a method of security interest recording that obviates or mitigates the need for a lending institution to use a third-party agent for security interest recording with government agencies.

It is an object of this invention to partially or completely fulfill one or more of the above-mentioned needs.

### SUMMARY OF THE INVENTION

The invention consists of a method for real-time registration of collateral for a loan, comprising: a) inputting collateral information into a form; b) verifying the collateral information in the form via a self-checking algorithm; c) submitting the collateral information to a registration service; and d) providing confirmation that the collateral information was recorded with the registration service.

The method may further include an additional step of providing suggested corrections when errors are identified.

Preferably, the collateral is a vehicle and the collateral information consists of a Vehicle Identification Number (VIN) corresponding to the manufacturer, model and year of the vehicle.

Other and further advantages and features of the invention will be apparent to those skilled in the art from the following detailed description thereof, taken in conjunction with the accompanying drawings.

### BRIEF DESCRIPTION OF THE DRAWINGS

The invention will now be described in more detail, by way of example only, with reference to the accompanying drawings, in which like numbers refer to like elements, wherein:

FIG. 1 is a flow chart of a preferred method of the present invention; and

FIG. 2 is a flow chart of a specific validation method for VINs (Vehicle Identification Numbers).

### DETAILED DESCRIPTION OF THE PREFERRED EMBODIMENTS

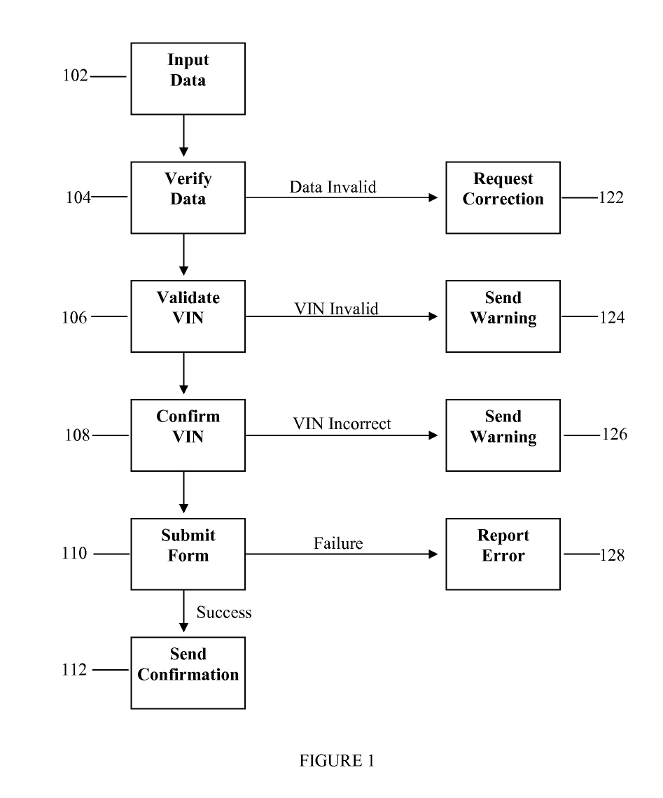

The inventive method, as shown in FIG. 1, consists of providing real-time registration of collateral for a lender using a government registration regime, such as the PPSA in Provinces of Canada or the UCC in States of the United States. Preferably, the method consists of providing a web-based transaction form for inputting (step 102) the necessary data to register the collateral, such as the amount of the loan, the type and identification of the collateral, the identity of the lending party and the identity of the borrowing party.

The transaction form includes intelligent error-checking to verify (step 104) the data input and to ensure compliance with registry requirements. If an error is found, the user is notified and provided an opportunity to correct the error (step 122). Preferably, the notification includes a suggested correction along with an indication of the nature of the error (e.g. omitted field, missing digits in phone number, etc.). As part of the error-checking system, a validation method (step 106) for ensuring that the collateral item is properly identified is also included, when possible.

For example, when a motor vehicle (car, SUV, passenger truck) is used as collateral, it is identified by its unique Vehicle Identification Number (VIN) for Canada and the United States (similar identification methods are used in other jurisdictions). The validity of the VIN can be self-confirmed as all VINs are based on a specific algorithm. If the VIN does not confirm as valid, a warning is generated (step 124) and the user is notified before any further steps are taken. However, this only confirms that the VIN is a valid one, not that it corresponds to the vehicle identified as collateral.

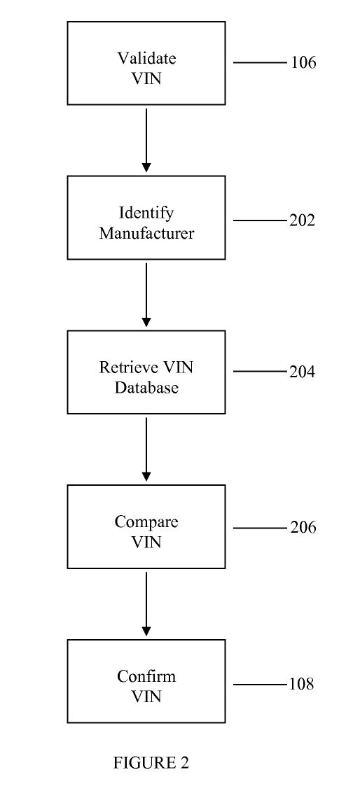

This validation process is thus taken one step further, as shown in FIG. 2. The validated VIN (step 106) is read to identify the manufacturer (step 202). The manufacturer's database then contacted to retrieve (step 204) the vehicle information associated with that VIN. This information is compared (step 206) against the vehicle information in the form to confirm the make, model and year of the vehicle (step 108). This information is then compared against the information in the transaction form to confirm the vehicle's VIN matches the information provided which identifies the vehicle used as collateral. Failure for the VIN information to match the provided vehicle information produces a warning (step 126) and the user is notified before any further steps are taken. Preferably, the nature of the match failure is provided, as in most cases it will likely prove to be an operator error in inputting the vehicle data (e.g. incorrect model year) rather than an intentional error.

The form is then submitted to the registry after verification (step 110). The confirmation response from the registry is received, along with a registration number, within seconds. If a confirmation response is not received, an error message is generated (step 128) and the user notified. Preferably, the user is provided with a choice to either re-send the form or abandon the transaction. On a successful registration, the registration number is then provided to the lending party (step 112) for its records, along with a representation of a verification statement from the registry, as there is typically no hard copy statement provided with a web-based registry transaction.

The transaction takes place in real-time, enabling confirmation of a successful registration to be received within minutes or even seconds. Thus, the entire loan transaction can be completed from a loan officer's desk, in the presence of the client. Risk is reduced, as there is no longer a need for gap insurance to cover the delay until registration. Furthermore, enabling the method through a web-based server system would allow for loan officers to handle the filing themselves, eliminating the need for external registration agents, reducing costs.

While the above method has been described preferably using a vehicle as collateral and a VIN as an identifier, it can be readily adapted to other products that provide for similar forms of identification, either currently or in the future. However, specific details of such adaptations are beyond the scope of this application.

This concludes the description of a presently preferred embodiment of the invention. The foregoing description has been presented for the purpose of illustration and is not intended to be exhaustive or to limit the invention to the precise form disclosed. Many modifications and variations are possible in light of the above teaching and will be apparent to those skilled in the art. It is intended the scope of the invention be limited not by this description but by the claims that follow.

What is claimed is:

1. A method for real-time registration of collateral for a loan, comprising:
a) inputting collateral information into a form;
b) verifying said collateral information in said form via a self-checking algorithm;
c) submitting said collateral information to a registration service;
d) providing confirmation that said collateral information was recorded with said registration service; and
e) providing a warning in the event steps b) and/or c) are unsuccessfully executed.

2. The method of claim 1, wherein said collateral is a vehicle and said collateral information includes a Vehicle Identification Number (VIN) for said vehicle.

3. The method of claim 2, further including an additional step of verifying said VIN as a legitimate VIN prior to said submitting step.

4. The method of claim 3, wherein said verification step for said VIN further includes confirmation that said VIN corresponds to said vehicle designated as said collateral.

5. The method of claim 1, further including, as part of said warning step e), suggesting a corrective procedure to allow for successful execution of said steps.

6. The method of claim 1, further including an additional step of providing a user with an opportunity to make changes to said form at each of steps b) and c).

7. The method of claim 6, wherein said additional step is enacted in response to a failure of any of steps b) and c).

8. A method for real-time validation of a Vehicle Identification Number (VIN) for a vehicle used as collateral, comprising:
a) verifying said VIN as a legitimate VIN using a VIN validation algorithm;
b) confirming said VIN corresponds to said vehicle by comparing said VIN against one or more vehicle VIN databases; and
c) notifying whether said VIN is successfully confirmed.

9. The method of claim 6, wherein said method is included a part of a method of registering said vehicle as collateral.

10. The method of claim 6, further including additional steps notifying of specific reasons for failure of any of steps a) and b) and providing suggestions corrections to address said failure.
